(19) United States
(12) Patent Application Publication
(10) Pub. No.: US 2026/0042609 A1
(43) Pub. Date: Feb. 12, 2026

(54) PICKING SYSTEM AND WAREHOUSE

(71) Applicant: MITSUBISHI HEAVY INDUSTRIES, LTD., Tokyo (JP)

(72) Inventors: Noriyuki HASEGAWA, Tokyo (JP); Tetsuhei KOBAYASHI, Tokyo (JP); Kensuke FUTAHASHI, Tokyo (JP)

(73) Assignee: MITSUBISHI HEAVY INDUSTRIES, LTD., Tokyo (JP)

(21) Appl. No.: 19/099,341

(22) PCT Filed: Feb. 17, 2023
(86) PCT No.: PCT/JP2023/005638

§ 371 Date: Jan. 28, 2025

(30) Foreign Application Priority Data
Aug. 29, 2022 (JP) 2022-135688

(51) Int. Cl. B65G 1/137; B66F 9/06

(52) U.S. Cl. CPC B65G 1/1378; B66F 9/063

(57) ABSTRACT

A picking system according to the present disclosure includes a first region in which a manned forklift or an unmanned forklift is operated, a second region that is disposed adjacent to the first region, and in which an unmanned forklift is operated, a third region that is disposed adjacent to the second region, and in which a palletizer is disposed and an unmanned transport vehicle is operated, a first delivery location that is provided at a boundary between the first region and the second region, and on which a replenishment pallet received by the manned forklift or the unmanned forklift or a shipment pallet carried by the unmanned forklift is placed, and a second delivery location that is provided at a boundary between the second region and the third region, and on which a replenishment pallet carried by the unmanned forklift or a shipment pallet carried by the unmanned transport vehicle is placed.

### TECHNICAL FIELD

The present disclosure relates to a picking system and a warehouse.

Priority is claimed on Japanese Patent Application No. 2022-135688, filed Aug. 29, 2022, the content of which is incorporated herein by reference.

### BACKGROUND ART

In the related art, there is a picking system for stacking a predetermined number of one or more types of articles from one or more types of replenishment pallets, in which the same type of articles are stacked and stored on a pallet, on another pallet (pallet for shipment) according to a shipment order, and shipping the articles as a shipment pallet.

Non-Patent Document 1 discloses a picking system including an automatic warehouse in which a plurality of types of replenishment pallets are stored, a conveyor that carries out a necessary type of replenishment pallet from the automatic warehouse according to a shipment order, and a palletizer (picking robot) that picks an article from a predetermined type of replenishment pallet carried out by the conveyor according to the shipment order and stacks the article on a pallet for shipment.

Non-Patent Document 2 discloses a picking system including a manned forklift that receives a replenishment pallet, a palletizer (picking robot) that picks an article from a required type of replenishment pallet according to a shipment order and stacks the article on a pallet for shipment, and an unmanned transport vehicle (AGV) that carries the received replenishment pallet to the palletizer. The unmanned transport vehicle is configured to support and transport various types of cargo from below. Therefore, in the picking system of Non-Patent Document 2, the manned forklift places the replenishment pallet on the transport stand with legs. The unmanned transport vehicle enters the lower side of the transport stand to transport the replenishment pallet.

### CITATION LIST

### Non-Patent Documents

Non-Patent Document 1:“Case Picking Robot”, [online], Daifuku Co., Ltd., [Searched on Aug. 8, 2022], Internet <URL:
https://www.daifuku.com/jp/solution/intralogistics/products/picking/case-picking-robot/>

Non-Patent Document 2:“Bargain Product Stacking Package”, [online], Mujin, Inc. [Searched on Aug. 8, 2022], Internet <URL:
https://www.mujin.co.jp/solution/distribution/tokubai/>

### SUMMARY OF INVENTION

### Technical Problem

In the picking system of the Non-Patent Document 1, fixed type equipment, such as an automatic warehouse and a conveyor, are used in addition to the palletizer. Therefore, it is not possible to easily change the layout of the picking system.

On the other hand, in the picking system of Non-Patent Document 2, only movable equipment excluding the palletizer is used. However, in the picking system of Non-Patent Document 2, it is necessary to place the replenishment pallet received by the manned forklift on a transport stand with legs. Therefore, it is not possible to arrange and dispose the replenishment pallets received by the manned forklift in the vertical direction, From this, it is not possible to dispose a large number of replenishment pallets at a delivery location of the replenishment pallet from the manned forklift to the unmanned transport vehicle, that is, a location (receiving location) where the replenishment pallet is received by the manned forklift. That is, there is a problem that the storage density of the replenishment pallets at the receiving location is low.

In a case where the storage density of the replenishment pallets at the receiving location is low and a large amount of the replenishment pallets are received by the manned forklift in a short time, there is a possibility that the transport of the replenishment pallets by the unmanned transport vehicle may not keep up. In this case, the reception of the replenishment pallet by the manned forklift is in a waiting state, and the restraint time of the operator who handles the manned forklift is increased.

The present disclosure has been made in order to solve the above-described problems, and an object of the present disclosure is to provide a picking system and a warehouse capable of improving a storage density of replenishment pallets in a receiving location while facilitating change of the layout of the picking system.

### Solution to Problem

In order to solve the above-described problem, a picking system according to the present disclosure includes a first region in which a manned forklift or an unmanned forklift is operated; a second region that is disposed adjacent to the first region, and in which an unmanned forklift is operated; a third region that is disposed adjacent to the second region, and in which a palletizer is disposed and an unmanned transport vehicle is operated; a first delivery location that is provided at a boundary between the first region and the second region, and on which a replenishment pallet received by the manned forklift or the unmanned forklift operated in the first region or a shipment pallet carried by the unmanned forklift operated in the second region is placed; and a second delivery location that is provided at a boundary between the second region and the third region, and on which a replenishment pallet carried by the unmanned forklift operated in the second region or a shipment pallet carried by the unmanned transport vehicle operated in the third region is placed.

A warehouse according to the present disclosure includes the picking system.

### Advantageous Effects of Invention

According to the present disclosure, it is possible to improve the storage density of the replenishment pallet in the receiving location while facilitating a change of the layout of the picking system.

### BRIEF DESCRIPTION OF DRAWINGS

FIG. 1 A disposition diagram of a picking system according to a first embodiment of the present disclosure, and is a diagram showing a situation in which a replenishment pallet is transported from a first region toward a palletizer.

FIG. 2 A diagram showing a situation in which a shipment pallet is transported from the palletizer toward a first region in FIG. 1.

FIG. 3 A side view showing an unmanned transport vehicle and a transport stand used in a picking system according to the first embodiment of the present disclosure,

FIG. 4 A disposition diagram of a picking system according to a second embodiment of the present disclosure.

FIG. 5 A disposition diagram of a picking system according to a third embodiment of the present disclosure.

### DESCRIPTION OF EMBODIMENTS

### First Embodiment

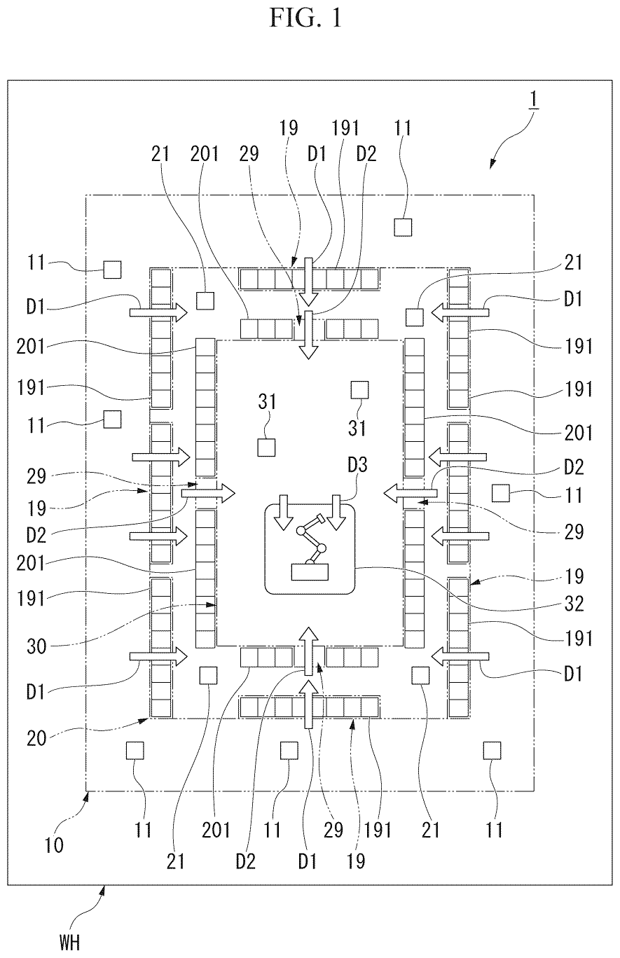

A first embodiment of the present disclosure will be described below with reference to FIGS. 1 to 3.

### Configuration of Picking System

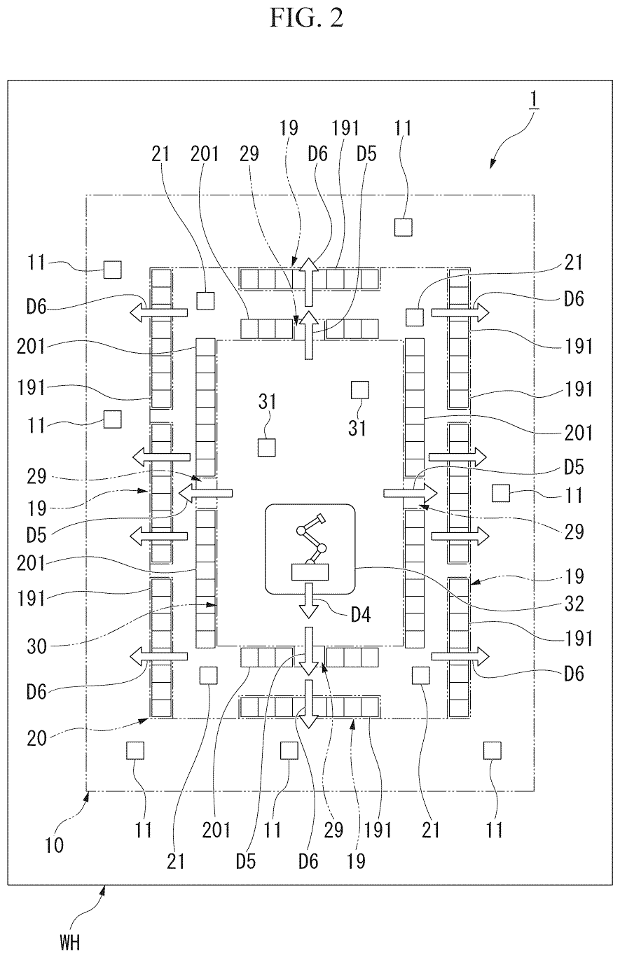

As shown in FIGS. 1 and 2, a picking system 1 is applied to, for example, a warehouse WH. The picking system 1 includes a first region 10 in which a manned forklift 11 operates, a second region 20 in which an unmanned forklift (AGF) 21 operates, a third region 30 in which an unmanned transport vehicle (AGV) 31 operates, a first delivery location 19, and a second delivery location 29. The second region 20 is disposed adjacent to the first region 10. In addition, the third region 30 is disposed adjacent to the second region 20. The number of manned forklifts 11, the number of unmanned forklifts 21, and the number of unmanned transport vehicles 31 disposed in each of the first, second, and third regions 10, 20, and 30 may be plural.

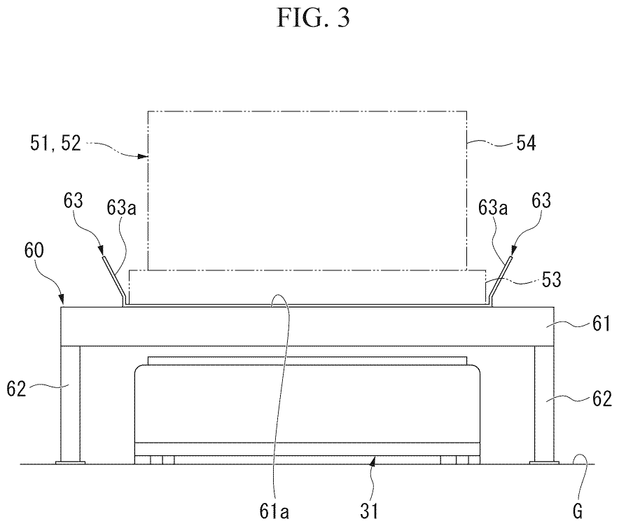

In the picking system 1 of the present embodiment, with the third region 30 as a center, the second region 20 is disposed to surround the third region 30 and the first region 10 is disposed to surround the second region 20. Specifically, the second region 20 is an annular region that completely surrounds the third region 30. In addition, the first region 10 is an annular region that completely surrounds the second region 20. In the example shown in the drawing, the third region 30 is formed in a rectangular region, and the second region 20 and the first region 10 are formed in rectangular annular regions each following the shape of the third region 30, but the present disclosure is not limited thereto, In the first region 10, the manned forklift 11 transports the replenishment pallet 51 or the shipment pallet 52 (see FIG. 3). In the second region 20, the unmanned forklift 21 transports the replenishment pallet 51 or the shipment pallet 52. In the third region 30, the unmanned transport vehicle 31 transports the replenishment pallet 51 or the shipment pallet 52. A palletizer 32 is disposed in the third region 30. As shown in FIG. 3, the replenishment pallet 51 is obtained by stacking one type of article 54 on the pallet 53.

The shipment pallet 52 is obtained by stacking one or more types of articles 54 on the pallet 53 by the palletizer 32 according to a shipment order.

### Unmanned Transport Vehicle and Transport Stand

The unmanned transport vehicle 31 is configured to lift and carry the replenishment pallet 51 or the shipment pallet 52 from below. Therefore, the picking system 1 includes a transport stand 60 that is mainly used in the third region 30 and the second delivery location 29.

The transport stand 60 includes a placement stand 61 and a leg portion 62. The placement stand 61 has a placement surface 61a on which the replenishment pallet 51 and the shipment pallet 52 are placed. The leg portion 62 extends downward from the placement stand 61. Therefore, in a state where the transport stand 60 is placed on the floor G, the placement stand 61 is positioned above the floor G at an interval by the leg portion 62. Accordingly, the unmanned transport vehicle 31 can enter the lower side of the placement stand 61 and transport the transport stand 60 by supporting the transport stand 60 from the lower side of the placement stand 61.

The transport stand 60 includes a guide portion 63. The guide portion 63 guides the pallet 53 in a direction along the placement surface 61a in a case where the pallet 53 of the replenishment pallet 51 or the shipment pallet 52 is placed on the placement surface 61a. The guide portion 63 includes an inclination guiding surface 63a. The inclination guiding surface 63a is a surface that extends in an inclined manner upward from the placement surface 61a and faces upward in the same manner as the placement surface 61a.

The two guide portions 63 are disposed at intervals in one direction (left-right direction in FIG. 3) along the placement surface 61a. The inclination guiding surfaces 63a of the two guide portions 63 face each other in one direction. Therefore, the interval between the inclination guiding surfaces 63a of the two guide portions 63 is widened as the distance increases upward from the placement surface 61a. The interval between the two guide portions 63 in the one direction is larger than the dimension of the pallet 53 in the one direction, but it is more preferable that the difference is small.

Since the transport stand 60 includes the guide portion 63, in a case where the pallet 53 is placed on the placement surface 61a of the transport stand 60, the pallet 53 is guided by the guide portion 63, and thus the pallet 53 can be disposed at a predetermined position on the placement surface 61a.

### Palletizer

The palletizer 32 is a picking robot that picks the article 54 from the predetermined type of replenishment pallet 51 and stacks the article 54 on the pallet 53 for shipment to form the shipment pallet 52 according to a shipment order. In the example shown in the drawing, the palletizer 32 is positioned away from the boundary with the second region 20 in the third region 30, but may be positioned at the boundary with the second region 20, for example.

### First Delivery Location

As shown in FIGS. 1 and 2, the first delivery location 19 is provided at a boundary between the first region 10 and the second region 20. The replenishment pallet 51 received by the manned forklift 11 operating in the first region 10 is placed at the first delivery location 19. The replenishment pallet 51 placed at the first delivery location 19 is carried to the second region 20 by the unmanned forklift 21. In addition, the shipment pallet 52 carried by the unmanned forklift 21 operating in the second region 20 is placed at the first delivery location 19. The shipment pallet 52 placed at the first delivery location 19 is carried to the first region 10 by the manned forklift 11.

In the present embodiment, the first delivery location 19 is provided with a shelf 191 (delivery shelf 191) in which a plurality of shelf boards are arranged in a vertical direction. Accordingly, a plurality of the replenishment pallets 51 or the shipment pallets 52 can be arranged in the vertical direction at the first delivery location 19.

In the example shown in the drawing, the delivery shelf 191 forming the first delivery location 19 is provided at most of the boundary between the first region 10 and the second region 20, but may be provided, for example, at the entire boundary between the first region 10 and the second region 20.

### Second Delivery Location

The second delivery location 29 is provided at a boundary between the second region 20 and the third region 30. The replenishment pallet 51 carried by the unmanned forklift 21 operating in the second region 20 is placed at the second delivery location 29. The replenishment pallet 51 placed at the second delivery location 29 is carried to the third region 30 by the unmanned transport vehicle 31. In addition, the shipment pallet 52 carried by the unmanned transport vehicle 31 operating in the third region 30 is placed at the second delivery location 29. The shipment pallet 52 placed at the second delivery location 29 is carried to the second region 20 by the unmanned forklift 21.

The second delivery location 29 is a simple floor. Then, at the second delivery location 29, the replenishment pallet 51 carried by the unmanned forklift 21 is placed on a placement surface 61a (see FIG. 3) of the transport stand 60. Therefore, the unmanned transport vehicle 31 carries the replenishment pallet 51 from the second delivery location 29 to the third region 30 together with the transport stand 60. In addition, the shipment pallet 52 is disposed at the second delivery location 29 by the unmanned transport vehicle 31 together with the transport stand 60. Therefore, the unmanned forklift 21 lifts the shipment pallet 52 from the transport stand 60 and carries the shipment pallet 52 to the second region 20.

The unmanned transport vehicle 31 cannot transport the replenishment pallets 51 and the shipment pallets 52 by stacking the replenishment pallets 51 and the shipment pallets 52. Therefore, at the second delivery location 29, the replenishment pallets 51 carried by the unmanned forklift 21 are not stacked in the vertical direction.

In the example shown in the drawing, four second delivery locations 29 are provided at intervals in the circumferential direction of the boundary between the second and third regions 20 and 30, but for example, the number of second delivery locations 29 may be equal to or less than three or equal to or greater than five. In addition, the plurality of second delivery locations 29 may be disposed adjacent to each other, for example.

### Storage Shelf

In the second region 20, a shelf 201 (storage shelf 201) for storing the replenishment pallet 51 carried from the first region 10 to the second region 20 or the shipment pallet 52 carried from the third region 30 to the second region 20 is disposed. In the present embodiment, the storage shelf 201 is disposed along the boundary with the third region 30 in the second region 20 to avoid the second delivery location 29. In addition, for example, a pallet 53 (empty pallet 53) on which the article 54 is not stacked up may be stored in the storage shelf 201.

### Operation of Picking System

Next, the operation of the picking system 1 according to the present embodiment will be described.

In the picking system 1, the replenishment pallet 51 can be transported from the first region 10 to the palletizer 32, and the shipment pallet 52 can be transported from the palletizer 32 to the first region 10.

First, the transportation of the replenishment pallet 51 from the first region 10 to the palletizer 32 will be described with reference to FIG. 1.

The replenishment pallet 51 received by the manned forklift 11 operating in the first region 10 is transported to the first delivery location 19. The replenishment pallet 51 transported to the first delivery location 19 is delivered to the unmanned forklift 21 that operates in the second region 20. An arrow D1 in FIG. 1 indicates a direction in which the replenishment pallet 51 is delivered from the manned forklift 11 to the unmanned forklift 21 at the first delivery location 19.

The unmanned forklift 21 transports the replenishment pallet 51 from the first delivery location 19. The unmanned forklift 21 transports a predetermined type of replenishment pallet 51 to the second delivery location 29 according to a shipment order, The unmanned forklift 21 may also transport the replenishment pallet 51 to the storage shelf 201. In this case, the unmanned forklift 21 may transport the replenishment pallet 51 from the storage shelf 201 to the second delivery location 29. The replenishment pallet 51 transported to the second delivery location 29 is delivered to the unmanned transport vehicle 31 that operates in the third region 30. An arrow D2 in FIG. 1 indicates a direction in which the replenishment pallet 51 is delivered from the unmanned forklift 21 to the unmanned transport vehicle 31 at the second delivery location 29.

The unmanned transport vehicle 31 transports one or more types of the replenishment pallets 51 to the palletizer 32 according to the shipment order. An arrow D3 in FIG. 1 indicates a direction in which the replenishment pallet 51 is delivered from the unmanned transport vehicle 31 to the palletizer 32. As described above, the transport of the replenishment pallet 51 from the first region 10 to the palletizer 32 is finished.

The palletizer 32 picks the article 54 from the predetermined type of replenishment pallet 51 and stacks the article 54 on the pallet 53 for shipment according to the shipment order. As a result, the shipment pallet 52 according to the shipment order is finished.

Next, the transport of the shipment pallet 52 from the palletizer 32 to the first region 10 will be described with reference to FIG. 2.

The finished shipment pallet 52 in the palletizer 32 is delivered from the palletizer 32 to the unmanned transport vehicle 31. An arrow D4 in FIG. 2 indicates a direction in which the shipment pallet 52 is delivered from the palletizer 32 to the unmanned transport vehicle 31.

The unmanned transport vehicle 31 transports the shipment pallet 52 to the second delivery location 29. The shipment pallet 52 transported to the second delivery location 29 is delivered to the unmanned forklift 21. An arrow D5 in FIG. 2 indicates a direction in which the shipment pallet 52 is delivered from the unmanned transport vehicle 31 to the unmanned forklift 21.

The unmanned forklift 21 transports the shipment pallet 52 from the second delivery location 29 to the first delivery location 19. The unmanned forklift 21 may transport the shipment pallet 52 from the second delivery location 29 to the storage shelf 201. In this case, the unmanned forklift 21 may transport the shipment pallet 52 from the storage shelf 201 to the first delivery location 19.

The shipment pallet 52 transported to the first delivery location 19 is delivered to the manned forklift 11. An arrow D6 in FIG. 2 indicates a direction in which the shipment pallet 52 is delivered from the unmanned forklift 21 to the manned forklift 11. As described above, the transport of the shipment pallet 52 from the palletizer 32 to the first region 10 is finished. Then, the shipment of the shipment pallet 52 is finished by transporting the shipment pallet 52 by the manned forklift 11.

In the picking system 1 of the present embodiment, the replenishment pallet 51 received by the manned forklift 11 in the first region 10 is delivered to the unmanned forklift 21 operating in the second region 20 at the first delivery location 19, Therefore, even in a case where the manned forklift 11 arranges the replenishment pallets 51 in the vertical direction at the first delivery location 19, the unmanned forklift 21 can transport the plurality of replenishment pallets 51 arranged in the vertical direction at the first delivery location 19 one by one in the second region 20. Therefore, a large number of replenishment pallets 51 can be disposed at the first delivery location 19. That is, the storage density of the replenishment pallet 51 at the first delivery location 19 that is the receiving location can be improved.

By improving the storage density of the replenishment pallets 51 at the first delivery location 19, it is possible to suppress the reception of the replenishment pallets 51 by the manned forklift 11 from being a waiting state even in a case where a large number of the replenishment pallets 51 are received by the manned forklift 11 in a short time. Therefore, it is possible to suppress an increase in the restraint time of the operator who handles the manned forklift 11.

In addition, in the second region 20, the replenishment pallets 51 transported from the first region 10 to the first delivery location 19 by the manned forklift 11 and the shipment pallets 52 transported from the third region 30 to the second delivery location 29 by the unmanned transport vehicle 31 can also be stored in a state of being arranged in the vertical direction. Specifically, in the storage shelf 201 provided in the second region 20, the replenishment pallets 51 and the shipment pallets 52 can be arranged in the vertical direction. Therefore, even in a case where the area of the second region 20 is small, a larger number of replenishment pallets 51 and the shipment pallets 52 can be stored in the second region 20.

In addition, the picking system 1 of the present embodiment is composed of only movable equipment of the manned forklift 11, the unmanned forklift 21, and the unmanned transport vehicle 31, except for the palletizer 32. Accordingly, it is possible to easily change the layout of the picking system 1.

In addition, in the picking system 1 of the present embodiment, the delivery shelf 191 is provided at the first delivery location 19. Accordingly, even in a case where the replenishment pallets 51 are arranged in the vertical direction at the first delivery location 19, the unmanned forklift 21 can transport the replenishment pallets 51 disposed on the lower side. That is, the unmanned forklift 21 can transport the desired replenishment pallet 51 from the first delivery location 19.

The same effect is also obtained in the storage shelf 201 provided in the second region 20.

In addition, in the picking system 1 of the present embodiment, the second region 20 is disposed to surround the third region 30, and the first region 10 is disposed to surround the second region 20. Therefore, even in a case where there is a restriction on the space in which the picking system 1 is disposed, the boundary (that is, the first delivery location 19) between the first region 10 and the second region 20 can be secured to be wide, as compared with a case where the first, second, and third regions 10, 20, and 30 are arranged in order in a straight line one by one. As a result, a larger number of manned forklifts 11 can access the first delivery location 19 at the same time, and the reception of the replenishment pallet 51 can be more effectively suppressed from being a waiting state. That is, it is possible to further suppress the increase in the restraint time of the operator who handles the manned forklift 11.

In addition, similarly to the boundary (first delivery location 19) between the first region 10 and the second region 20, it is also possible to widely secure the boundary (second delivery location 29) between the second region 20 and the third region 30. Accordingly, it is possible to effectively suppress the replenishment pallet 51 or the shipment pallet 52 from staying at the second delivery location 29.

In addition, in the picking system 1 of the present embodiment, the transport stand 60 includes the guide portion 63 that guides the pallet 53 of the replenishment pallet 51 or the shipment pallet 52 in the direction along the placement surface 61a in a case where the replenishment pallet 51 or the shipment pallet 52 is placed on the placement surface 61a. Accordingly, in a case where the replenishment pallet 51 is placed on the placement surface 61a of the transport stand 60 disposed at the second delivery location 29 by the unmanned forklift 21, the position of the replenishment pallet 51 placed on the placement surface 61a can be corrected by the guide portion 63 of the transport stand 60. Therefore, in a case where the unmanned forklift 21 attempts to place the replenishment pallet 51 on the placement surface 61a of the transport stand 60, even though the replenishment pallet 51 supported by the unmanned forklift 21 and the transport stand 60 are misaligned in the direction along the placement surface 61a, the replenishment pallet 51 can be placed at the correct position on the placement surface 61a. That is, even in a case where the position accuracy of the unmanned forklift 21 placing the replenishment pallet 51 at the second delivery location 29 and the position accuracy of the unmanned transport vehicle 31 disposing the transport stand 60 at the second delivery location 29 are low, the replenishment pallet 51 can be placed at the correct position on the placement surface 61a.

### Second Embodiment

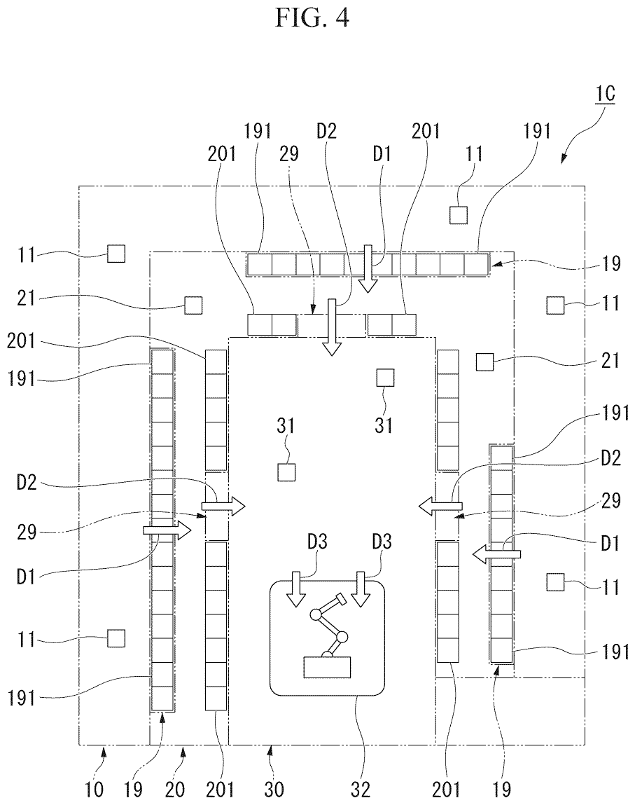

Next, a second embodiment of the present disclosure will be described with reference to FIG. 4. In the following description, the configurations that are the same as the configurations already described will be given the same reference signs, and duplicate descriptions thereof will be omitted.

As shown in FIG. 4, in a picking system 1C of the second embodiment, similarly to the first embodiment, with the third region 30 as a center, the second region 20 is disposed to surround the third region 30, and the first region 10 is disposed to surround the second region 20. However, in the second embodiment, the first and second regions 10 and 20 do not completely surround the third region 30. A part of the third region 30 in the circumferential direction is not in contact with the first and second regions 10 and 20. A portion of the third region 30 in the circumferential direction that is not in contact with the first and second regions 10 and 20 is smaller than a portion that is in contact with the first and second regions 10 and 20.

In the example shown in the drawing, the second region 20 is a C-shaped region that surrounds a part of the third region 30 in the circumferential direction. In addition, the first region 10 is a C-shaped region surrounding the second region 20.

Although not shown, the picking system 1C of the second embodiment may be applied to, for example, the warehouse WH (see FIGS. 1 and 2) in the same manner as in the first embodiment.

Next, an operation of the picking system 1C of the second embodiment will be described. In the picking system 1C of the second embodiment, as in the first embodiment, the replenishment pallet 51 can be transported from the first region 10 to the palletizer 32. Further, as in the first embodiment, the shipment pallet 52 can also be transported from the palletizer 32 to the first region 10.

Further, in the picking system 1C of the second embodiment, the shipment pallet 52 can be shipped from the palletizer 32 without passing through the second and first regions 20 and 10. In this case, the shipment pallet 52 may be transported to the outside of the third region 30 through the edge of the third region 30 that is not in contact with the first and second regions 10 and 20 from the palletizer 32. The transport of the shipment pallet 52 may be performed by the unmanned transport vehicle 31. In a case where the shipment pallet 52 is directly transported to the outside from the third region 30, the first region 10 and the second region 20 function as dedicated regions for transporting the replenishment pallet 51 to the third region 30.

According to the picking system 1C of the second embodiment, the same effects as those of the first embodiment are obtained.

### Third Embodiment

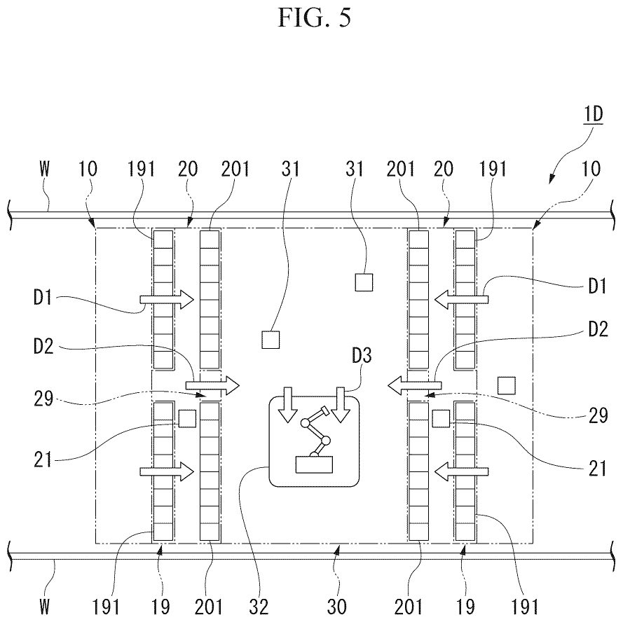

Next, a third embodiment of the present disclosure will be described with reference to FIG. 5. In the following description, the configurations that are the same as the configurations already described will be given the same reference signs, and duplicate descriptions thereof will be omitted.

As shown in FIG. 5, in the picking system 1D of the third embodiment, the first region 10, the second region 20, and the third region 30 are disposed adjacent to each other in order as in the first and second embodiments. However, in the third embodiment, two second regions 20 are disposed to sandwich the third region 30. In addition, two first regions 10 are disposed to sandwich the third region 30 and the two second regions 20. That is, the first-first region 10, the first-second region 20, the third region 30, the second-second region 20, and the second-first region 10 are arranged in order in one direction (in FIG. 5, the left-right direction).

The picking system 1D shown in FIG. 5 is provided in a region sandwiched between two walls W arranged in an orthogonal direction (upward and downward direction in FIG. 5) orthogonal to the one direction, but the present disclosure is not limited thereto. Although not shown in the drawing, the picking system 1D of the third embodiment may be applied to, for example, the warehouse WH (see FIGS. 1 and 2) in the same manner as in the first embodiment.

In the picking system 1D of the third embodiment, as in the first embodiment, the replenishment pallet 51 can be transported from the first region 10 to the palletizer 32, and the shipment pallet 52 can be transported from the palletizer 32 to the first region 10. In FIG. 5, arrows D1, D2, and D3 indicating the delivery direction of the replenishment pallet 51 in a case where the replenishment pallet 51 is transported from the first region 10 to the palletizer 32 are shown.

In a case where the picking system 1D of the third embodiment is not sandwiched between the two walls W, the shipment pallet 52 can also be shipped from the palletizer 32 without passing through the second and first regions 20 and 10, as in the second embodiment.

According to the picking system 1D of the third embodiment, the same effects as those of the first and second embodiments can be obtained.

In addition, in the picking system 1D of the third embodiment, two second regions 20 are disposed to sandwich the third region 30, and two first regions 10 are disposed to sandwich the third region 30 and the two second regions 20. Therefore, even in a case where the second region 20 and the first region 10 cannot be disposed to surround the third region 30 due to a restriction such as the wall W (or the column), the boundary (first delivery location 19) between the first region 10 and the second region 20 can be widely secured.

Although the embodiments of the present disclosure have been described in detail with reference to the drawings, the specific configuration is not limited to these embodiments, and design change and the like within a range that do not deviate from the gist of the present disclosure are also included.

In the present disclosure, the delivery shelf 191 may not be disposed at the first delivery location 19. That is, the replenishment pallets 51 and the shipment pallets 52 may be stacked in the vertical direction at the first delivery location 19. In such a case, the unmanned forklift 21 can transport the replenishment pallets 51 stacked at the first delivery location 19 to the second region 20. Similarly, the manned forklift 11 can transport the shipment pallets 52 stacked at the first delivery location 19 to the first region 10. Therefore, even in a case where the first delivery location 19 is a simple floor or the like, a large number of replenishment pallets 51 can be disposed at the first delivery location 19.

In the present disclosure, in the first region 10, the operation is not limited to the manned forklift 11 and, for example, the unmanned forklift may be operated.

In the present disclosure, for example, the first, second, and third regions 10, 20, and 30 may be arranged in order in a straight line one by one.

### Appendix

The picking systems 1, 1C, and 1D described in the above-described embodiments are understood as follows, for example.

(1) The picking systems 1, 1C, and 1D according to a first aspect are picking systems 1, 1C, and 1D each including: a first region 10 in which a manned forklift 11 or an unmanned forklift is operated, a second region 20 that is disposed adjacent to the first region 10 and in which an unmanned forklift 21 is operated, a third region 30 that is disposed adjacent to the second region 20 and in which a palletizer 32 is disposed and an unmanned transport vehicle 31 is operated, a first delivery location 19 that is provided at a boundary between the first region 10 and the second region 20, and on which a replenishment pallet 51 received by the manned forklift 11 or the unmanned forklift operated in the first region 10 or a shipment pallet 52 carried by the unmanned forklift 21 operated in the second region 20 is placed, and a second delivery location 29 that is provided at a boundary between the second region 20 and the third region 30, and on which a replenishment pallet 51 carried by the unmanned forklift 21 operated in the second region 20 or a shipment pallet 52 carried by the unmanned transport vehicle 31 operated in the third region 30 is placed.

In the above configuration, the replenishment pallet 51 received by the manned forklift 11 or the unmanned forklift in the first region 10 is delivered to the unmanned forklift 21 operating in the second region 20 at the first delivery location 19. Therefore, even in a case where the manned forklift 11 or the unmanned forklift operating in the first region 10 arranges the replenishment pallets 51 at the first delivery location 19 in the vertical direction, the unmanned forklift 21 can transport the plurality of replenishment pallets 51 arranged in the vertical direction at the first delivery location 19 one by one in the second region 20. Therefore, a large number of replenishment pallets 51 can be disposed at the first delivery location 19. That is, the storage density of the replenishment pallet 51 at the first delivery location 19 that is the receiving location can be improved.

By improving the storage density of the replenishment pallets 51 at the first delivery location 19, it is possible to suppress the reception of the replenishment pallets 51 by the manned forklift 11 from being a waiting state even in a case where a large number of the replenishment pallets 51 are received by the manned forklift 11 in a short time. Therefore, it is possible to suppress an increase in the restraint time of the operator who handles the manned forklift 11.

In addition, the picking systems 1, 1C, and 1D having the above configuration can be configured by only movable equipment of the manned forklift 11, the unmanned forklift 21, and the unmanned transport vehicle 31, except for the palletizer 32. Accordingly, it is possible to easily change the layout of the picking system 1.

(2) The picking systems 1 and 1C according to a second aspect are the picking systems 1 and 1C of the first aspect, in which the second region 20 is disposed to surround the third region 30, and the first region 10 is disposed to surround the second region 20.

In the above configuration, the boundary (that is, the first delivery location 19) between the first region 10 and the second region 20 can be secured to be wide even in a case where there is a restriction on the space in which the picking system 1 is disposed, as compared with a case where the first, second, and third regions 10, 20, and 30 are arranged in order in a straight line one by one. As a result, a larger number of manned forklifts 11 can access the first delivery location 19 at the same time, and the reception of the replenishment pallet 51 can be more effectively suppressed from being a waiting state. That is, it is possible to further suppress the increase in the restraint time of the operator who handles the manned forklift 11.

In addition, similarly to the boundary (first delivery location 19) between the first region 10 and the second region 20, the boundary (second delivery location 29) between the second region 20 and the third region 30 can also be widely secured. Accordingly, it is possible to effectively suppress the replenishment pallet 51 or the shipment pallet 52 from staying at the second delivery location 29.

(3) The picking system 1D according to a third aspect is the picking system 1D of the first aspect, in which two second regions 20 are disposed to sandwich the third region 30, and two first regions 10 are disposed to sandwich the third region 30 and the two second regions 20.

In the above configuration, even in a case where the second region 20 and the first region 10 cannot be disposed to surround the third region 30 due to the restriction of the wall W, the column, or the like, the boundary (that is, the first delivery location 19) between the first region 10 and the second region 20 can be widely secured.

(4) The picking systems 1, 1C, and 1D according to a fourth aspect are the picking systems 1, 1C, and 1D according to any one of the first to third aspects, each including a transport stand 60 that has a placement stand 61 on which the replenishment pallet 51 or the shipment pallet 52 is placed, and is supported and transported by the unmanned transport vehicle 31 from a lower side of the placement stand 61 at the third region 30 and the second delivery location 29, in which the transport stand 60 includes a guide portion 63 that guides the replenishment pallet 51 or the shipment pallet 52 in a direction along the placement surface 61a in a case where the replenishment pallet 51 or the shipment pallet 52 is placed on the placement surface 61a.

In the above configuration, in a case where the replenishment pallet 51 is placed on the placement surface 61a of the transport stand 60 disposed at the second delivery location 29 by the unmanned forklift 21, the position of the replenishment pallet 51 placed on the placement surface 61a can be corrected by the guide portion 63 of the transport stand 60. Therefore, in a case where the unmanned forklift 21 attempts to place the replenishment pallet 51 on the placement surface 61a of the transport stand 60, even though the replenishment pallet 51 supported by the unmanned forklift 21 and the transport stand 60 are misaligned in the direction along the placement surface 6la, the replenishment pallet 51 can be placed at the correct position on the placement surface 61a. That is, even in a case where the position accuracy of the unmanned forklift 21 placing the replenishment pallet 51 at the second delivery location 29 and the position accuracy of the unmanned transport vehicle 31 disposing the transport stand 60 at the second delivery location 29 are low, the replenishment pallet 51 can be placed at the correct position on the placement surface 61a.

(5) The warehouse WH according to a fifth aspect includes the picking systems 1, 1C, and 1D according to any one of the first to fourth aspects.

In the above configuration, it is possible to provide the warehouse WH in which the storage density of the replenishment pallet in the receiving location can be improved.

### INDUSTRIAL APPLICABILITY

The present disclosure relates to a picking system and a warehouse capable of improving a storage density of the replenishment pallet in the receiving location while facilitating a change of the layout of the picking system.

### REFERENCE SIGNS LIST

1, 1C, 1D Picking system
10 First region
11 Manned forklift
19 First delivery location
20 Second region
21 Unmanned forklift
29 Second delivery location
30 Third region
31 Unmanned transport vehicle
32 Palletizer
51 Replenishment pallet
52 Shipment pallet
60 Transport stand
61 Placement stand
61a Placement surface
63 Guide portion

1. A picking system comprising:
a first region in which a manned forklift is operated;
a second region that is disposed adjacent to the first region, and in which an unmanned forklift is operated;
a third region that is disposed adjacent to the second region on a side opposite to the first region, in which a palletizer which creates a shipment pallet by picking an article from a replenishment pallet is disposed, and in which an unmanned transport vehicle which transports the replenishment pallet to the palletizer and transports the shipment pallet delivered from the palletizer is operated;
a first delivery location that is provided at a boundary between the first region and the second region, and on which the replenishment pallet received by the manned forklift operated in the first region or the shipment pallet carried by the unmanned forklift operated in the second region is placed; and
a second delivery location that is provided at a boundary between the second region and the third region, and on which the replenishment pallet carried by the unmanned forklift operated in the second region or the shipment pallet carried by the unmanned transport vehicle operated in the third region is placed, wherein
in the first delivery location, a plurality of delivery shelves are arranged along the boundary between the first region and the second region, and each of the plurality of delivery shelves configured to stack and arrange the replenishment pallets or the shipment pallets in a vertical direction is provided.

2. The picking system according to claim 1, wherein
the second region is disposed to surround the third region, and
the first region is disposed to surround the second region.

3. The picking system according to claim 1, wherein
two second regions are disposed to sandwich the third region, and
two first regions are disposed to sandwich the third region and the two second regions.

4. The picking system according to claim 1, further comprising:
a transport stand configured to have a placement stand including a placement surface on which the replenishment pallet or the shipment pallet is placed; and configured to be supported and transported by the unmanned transport vehicle from a lower side of the placement stand at the third region and the second delivery location, wherein
the transport stand includes a guide portion that guides the replenishment pallet or the shipment pallet in a direction along the placement surface in a case where the replenishment pallet or the shipment pallet is placed on the placement surface.

5. A warehouse comprising:
the picking system according to claim 1.
